(19) United States
(12) Patent Application Publication
(10) Pub. No.: US 2025/0036683 A1
(43) Pub. Date: Jan. 30, 2025

(54) Apparatus and Method for Optimizing an Algorithm to Convert to Hardware and System Made

(71) Applicant: DarkHash, Inc., San Jose, CA (US)

(72) Inventor: Erfan Jason Davami, Austin, TX (US)

(21) Appl. No.: 18/357,734

(22) Filed: Jul. 24, 2023

(51) Int. Cl. G06F 16/901

(52) U.S. Cl. CPC G06F 16/9024

(57) ABSTRACT

Various embodiments of a method and apparatus are disclosed for creating a new device that implements an algorithm, subject to specified constraints. In some embodiments, an initial algorithm and constraints are received and converted to a new algorithm, upon which the device is based. The method further includes constructing a DAG (Directed Acyclic Graph) from the algorithm received and then reconstructing the DAG to accommodate the constraints. The method and system identify outputs that are of interest, trace the outputs of interest back to the inputs, and ignore inputs and the parts of the DAG that are not needed for generating the outputs of interest. When computing multiple jobs in parallel that each use the same DAG, portions of inputs that are shared by two parallel jobs, and portions of the DAG that compute the shared inputs are determined, and that therefore only need to be computed once.

### BACKGROUND

### (1) Technical Field

The disclosed method and apparatus relate generally to systems for creating a device that implements an algorithm, based on one or more constraints and the device made by the method and apparatus. In particular, the disclosed method and apparatus relate to a system and method for creating an efficient BTC (Bitcoin) mining chip and the BTC chip created.

### (2) Background

Optimizing an algorithm often needs to be performed manually. It can be difficult and time-consuming to manually optimize the algorithm. Manually optimizing the algorithm can cost a company many engineering months or even years for larger algorithms. Also, the more complex a chip, the more expensive the chip. BTC mining rigs can be expensive. BTC mining rigs can also consume enough power to make them unprofitable. To keep BTC mining profitable, the cost of the mining chip and the cost of running the chip should be kept low. Therefore, it is desirable to optimize mining rigs for mining BTCs. The faster a hash value can be generated from a nonce, the more jobs can be processed in a given period of time. This allows more nonces to be tried during that time, resulting in more coins mined and a more profitable mining rig.

Accordingly, providing a system that automatically analyzes and rewrites an algorithm would be advantageous. In particular, it would be advantageous to provide a system that automatically optimizes an algorithm and a specialized chip for implementing the algorithm, making a more efficient BTC mining rig by keeping the number of hardware components on the chip low and the chip's speed fast.

### SUMMARY

Various embodiments of a method and apparatus for creating a new device that implements an algorithm, subject to specified constraints, are disclosed.

In various embodiments, an apparatus is provided for building a device that implements an algorithm while conforming to one or more constraints. In some embodiments, the apparatus includes a code parser, a DAG builder, a DAG optimizer, and a device builder that builds the device based on the optimized DAG, which in turn is based on the constraints.

The DAG builder converts the parsed code into a DAG. The DAG optimizer optimizes the DAG to conform to the constraints and reduce the number of computations. In some embodiments, the DAG optimizer determines the outputs of interest and traces the outputs back to inputs to determine the portions of the DAG that are not needed for computing the outputs of interest. The DAG optimizer discards the portions of the DAG that do not affect the outputs of interest. While tracing the DAG backward, the nodes (and in some embodiments the edges) traversed (to find the inputs) are labeled and in some embodiments recorded. The nodes and edges that are not labeled are ignored. The subDAG that affects the outputs of interest is modified to conform to constraints. The DAG optimizer divides the portion of the DAG that affects the outputs of interest into smaller subDAGs. In some embodiments, each subDAG is compared to other subDAGs, and operators of the subDAGs that can be combined are combined to reduce the total number of terms in the final results.

In some embodiments, when computing multiple hash values in parallel. The portions of the DAGs that can be shared are determined so that the number of, or size of, the shared portions of the parallel DAGs can be maximized. To facilitate merging parallel DAGs, a search is performed for similar/or shared nodes among the inputs of the DAGs, and the DAG is traced forwards from the shared nodes to determine the portions of the DAG that process the shared nodes.

In some embodiments, the input to the DAG optimized for BTC (Bitcoin) includes a block candidate and a nonce. The block candidate is processed by a conversion subgraph that is not affected by the nonce. The results of the conversion subgraph are converted to a different header than the BTC header. The converted header and the nonce are input to the nonce-dependent subgraph. In performing the computation, only the last 64 bits of the output need to be computed repeatedly. Accordingly, the portion of the subgraphs that are not used for computing the last 64 bits can be ignored. By ignoring the parts of the DAG that do not affect the last 64 bits when repeating the computation of the hash, the computation can be performed more efficiently and requires less power for the computation of the hash.

In some embodiments, a group of parallel DAGs for computing a BTC hash includes three phases of logic. The three phases are three different procedures. The three phases differ in which input each receives (among other things) and which part of the job each phase processes. The key and nonce are fed into shared logic, which is logic that is shared by multiple cores (where each core processes a different job). A first phase receives part A of the job, the constants alpha and beta, and the nonce. A second phase receives the output of the first phase and the output of shared logic. The third phase receives part B of the job and the output of the second phase. In some embodiments, each of the three phases has a unique set of constraints.

The parallel DAGs can be broken down into a set of primitive components, which are referred to component clusters, which are similar to building blocks from which the three phases can be constructed.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates a block diagram of an example of an apparatus for converting an algorithm to a device that implements an optimized version of the algorithm.

FIG. 2 illustrates an example of a DAG representing an algorithm.

FIG. 3 illustrates an example of a new DAG created from the DAG of FIG. 2, based on the constraints.

FIG. 4 illustrates the equation from which the DAG of FIG. 3 is created.

FIG. 5 is an example of a DAG of an algorithm prior to combining operators.

FIG. 6 illustrates a DAG of an algorithm that results after combining the operators of the DAGs of FIG. 5.

FIG. 7 illustrates an example of tracing a DAG backward to determine which inputs affect a particular output.

FIG. 8 illustrates a system and flow diagram for creating a hash.

FIG. 9 illustrates a block diagram of various embodiments of a system including a constellation.

FIG. 10 illustrates various embodiments of a first component cluster of an optimized DAG for BTC mining.

FIG. 11 illustrates various embodiments of a second component cluster of an optimized DAG for BTC mining.

FIG. 12 illustrates various embodiments of a third component cluster of an optimized DAG for BTC mining.

FIG. 13 illustrates various embodiments of a fourth component cluster of an optimized DAG for BTC mining.

FIG. 14 illustrates a flowchart of an example of a method for converting an initial algorithm to a new algorithm and creating a device based on the new algorithm.

FIG. 15 illustrates a flowchart of various embodiments of a step of finding shared logic for creating a constellation based on the new algorithm.

FIG. 16 illustrates a method of operating the device constructed by the method of FIG. 14 for computing multiple hash values in parallel.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

### An Embodiment of the System

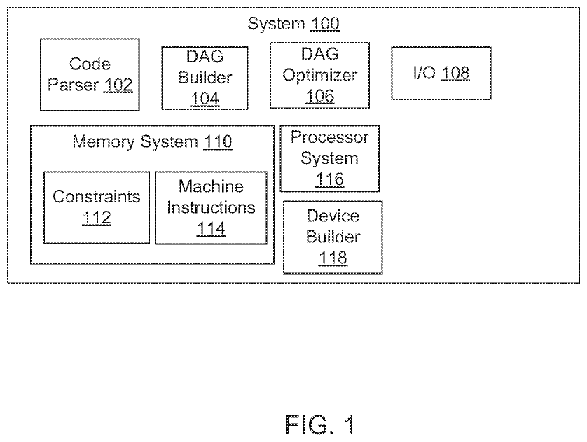

FIG. 1 illustrates a block diagram of an example of an apparatus 100 for building a device that implements an algorithm while conforming to one or more constraints. The apparatus 100 includes a code parser 102, a Directed Acyclic Graph (DAG) builder 104, a DAG optimizer 106, an Input/Output (I/O) 108, a memory system 110 storing constraints 112 and machine instructions 114, a processor system 116 and a device builder 118.

The apparatus 100 receives an initial algorithm, optimizes the algorithm and builds a device that implements the algorithm while conforming to one or more constraints. The code parser 102 receives a code (i.e., an algorithm) and parses the code, searching for, and identifying variables and operators (the variables include operands of the operators and results of applying the operators to the operands). In some embodiments, the operators include numerical, logical and text operators.

The DAG builder 104 converts the parsed code into an initial DAG. In some embodiments, two types of nodes are included in the DAG. One type of node represents the operators, and the other type of node represents variables. Since some logical operators (such as full-adders) could produce more than two results (the node may have more than two left-side operands), it is helpful to distinguish between an operator returning multiple variables and an operator returning just one variable that is used in more than one other future operator to track how an operator is related to its children and parents. By denoting the variables as nodes, it is not necessary to expressly track that distinction, because if an equation has two results, the nodes of the equation will be connected in the forward direction along the DAG to two nodes, one for each result variable, whereas if the equation has one result, the equation will only be connected in the forward DAG direction to one node. Hence, there is an advantage to treating a variable as a node, because that tracks how many results are produced by an operator. Likewise, were the operators used as edges and the variables used as nodes, then when results of an operator are used by two operators, two edges would be needed for one equation.

In an alternative embodiment, there is only one type of node that represents the equations/components, and the variables are represented as edges of the graph.

The DAG optimizer 106 optimizes the DAG. In some embodiments, the DAG optimizer 106 determines the outputs of interest and traces the outputs of interest back to inputs to determine the portions of the DAG that are not needed for computing the outputs of interest. The DAG optimizer 106 discards the portions of the DAG that do not affect the outputs of interest. DAG optimizer 106 determines nodes that can be combined, and then the DAG optimizer 106 combines the combinable nodes. For example, multiple additions and subtractions can be combined as a single addition or subtraction, and multiple multiplications and divisions can be replaced with a single multiplication or division. Some other examples of combining combinable operators include combining two terms of the same function of the same variables, by combining the constant coefficients (e.g., replacing 5X²Y³+7 X²Y³ with 12 X²Y³ or replacing 3 cos (X*Y)+cos(X*Y) with 4 cos (X*Y)) and combining two functions, which when combined become a third function (e.g., replacing cos²(x)+sin²(x) with 1 or cos²(x)−sin²(x) with cos(2x)).

Additionally, at least some non-mergeable operators are rearranged to expand or simplify the graph, by factoring out common factors. For example, a DAG may include the following nodes:

$$X 0 = a * b ;$$

$$X 1 = a * c ;$$

$$and$$

$$X 2 = X 0 + X 1 .$$

In the above nodes, a, b and c are symbolic variables and therefore cannot be combined. The above nodes can nonetheless be simplified as follows:
X2=a*(b+c), and consequently, in some embodiments,
Y0=b+c is defined. Substituting Y0 into the expression for X2 gives,
X2=a*Y0.

For binary equations/logic expressions, for example, consider the expression

$$L 0 = ( A AND C ) OR ( A AND D ) OR ( B AND C ) OR ( B AND D ) ,$$

where A, B, C and D are symbolic logical variables and therefore cannot be combined. Nonetheless, LO can be simplified by factoring out common factors (e.g., A and B), which yields:

$$L 0 = ( A OR B ) AND ( C OR D ) .$$

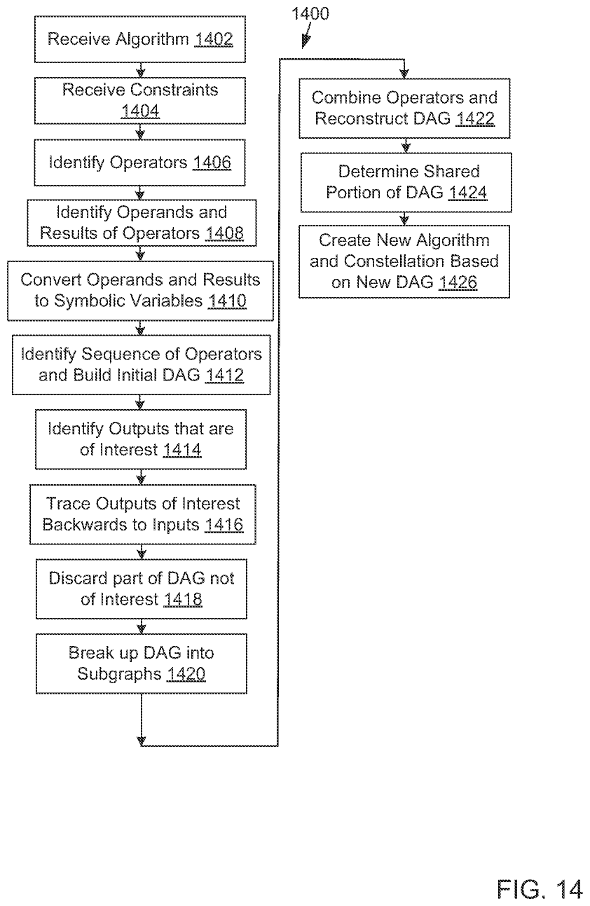

In some embodiments, each subDAG is compared to other subDAGs, which in some embodiments are the subDAG's children (DAG optimizer 106 is discussed further in conjunction with FIG. 14). When computing a DAG to perform several parallel jobs, the DAG optimizer 106 determines portions of the parallel DAGs that only need to be computed once for multiple parallel jobs, so that only one copy of the hardware needs to be placed on the device, and that copy of the hardware is shared by multiple parallel DAGs.

In some embodiments, the DAG optimizer 106 divides the remaining part of the initial DAG into smaller independent pieces, which in some embodiments are subDAGs. Separating the received algorithm into smaller units could be performed without any foreknowledge of the algorithm received. When implementing the algorithm of the DAG, each independent piece of the algorithm could be placed on a thread of a CPU (Central Processor Unit) or GPU (General Processor Unit) by addressing the thread by the thread's ID. Wider and more shallow DAGs are more efficiently executed on a GPU, while thinner and deeper DAGs are better suited to run on CPU threads.

The I/O 108 includes input/output devices, such as wireless interfaces, network interfaces and ports such as USB ports or ethernet ports. In some embodiments, the I/O 108 includes ports for keyboards, touchscreens and/or pointing devices, such as mice, touchpads and trackballs. The I/O 108 receives the initial code and the constraints 112. The memory system 110 stores the constraints 112 and the machine instructions 116. Some examples of constraints 112 are a maximum number of operators allowed per layer, a maximum allowed area of IC (Integrated Circuit) surface area for implementing the algorithm, a maximum allowed size of LUTs (Lookup Tables), a maximum allowed-number of operands per operator, a maximum allowed-number of results per operator, and a maximum allowed time delay per layer.

In some embodiments, optimization parameters are received, which determine the criteria used for optimizing the algorithm (subject to the constraints). Some examples of optimization criteria are minimizing the time required for computing the algorithm, minimizing the cost of manufacturing the component, minimizing the number of expensive mathematical operations, such as multiplication and division, minimizing the number of computations and maximizing the number of operators processed simultaneously. Expensive mathematical operations are mathematical operations that require more computing resources than simpler operations such as adding or subtracting. For example, expensive mathematical operations include those that are composed of simpler operations (e.g., multiplication can be performed by multiple additions).

In some embodiments, the machine instructions 116 include the code parser 102, the DAG builder 104 and the DAG optimizer 106. In some embodiments, the machine instructions 114 parse the initial algorithm, build and optimize a DAG and design a device based on the optimized DAG. The processor system 116 implements the machine instructions stored in the memory 110. The device builder 118 builds a device that implements the algorithm that is based on the optimized DAG.

### An Example of an Initial Dag

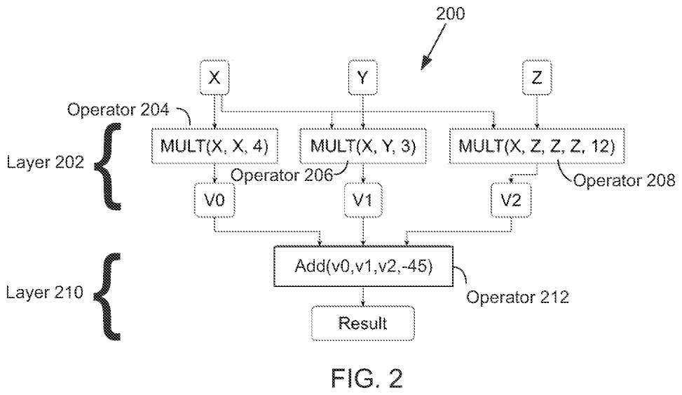

FIG. 2 illustrates an example of a DAG 200 created based on an algorithm. In the example of DAG 200, the algorithm computes an equation for F=4X²−3YX+12XZ³-45, which is the initial algorithm.

In the example of FIG. 2. X² is replaced with X*X, and Z³ is replaced with Z*Z*Z.

In DAG 200, in a first layer 202, three operators, 204, 206 and 208, are identified. The first operator 204 identified is 4X² (EQ0), which has three operands (the 4 and the two Xs). The result of the operator operating on the first set of operands is V0. The next operator 206 is identified as 3XY (EQ1) and as having three operands, X and Y and 3, and one result, V1. The third operator 208 is 12XZ³ (EQ2), which has five operands, three of which have the value Z, one of which has the value X, and one of which is the number 12. The result of operator 12XZ³ is V2. The three results, V0, V1 and V2, are also the operands to the operator of the next layer 210. The next layer 210 has just one operator 212, which has operands V0, V1 and V2. Operator 212 sums operands V0, V1, V2 and a constant, which is −45 (EQ3). The result of operator 212, V4, is the result of DAG 200 (although the next layer has only one operator, and although in the example of FIG. 2 there are just two layers of operators, other algorithms may have a different number of layers and operands in each layer).

Although the DAG of FIG. 2 is an equation, the same principles can be used to compute an algorithm that is not an equation. The inputs X, Y, Z, operands and results of the operators V0, V1 and V2 are converted to symbolic variables.

For example, using the algorithm of FIG. 2, system 100 may receive the following C++ code that implements the function F (4X²−3YX+12Z³−45) as:

double compute_polynomial(double x, double y, double z) {
return 4 * x * x − 3 * x * y + 12 * x * z * z * z − 45;
}

Ordinarily, because the type ‘double’ is a numeric type, the compiler would treat the operators ‘*’, ‘+’ and ‘−’ as arithmetic operators and would generate bytecode that only accepts numerical inputs and would return a numerical value. However, it is desirable to store a representation of such operations (instead of implementing the operators), so that the representation is symbolic. Similarly, in some embodiments, logical operators, text operators and arithmetic operators are converted to representations of the operators. To replace the numeric operation with symbolic operations, a custom type is defined, and in some embodiments, the following pseudocode is implemented:

```
class DarkHashVariable {
  DarkHashVariable operator + (DarkHashVariable other) {
    if (*this−>isAnActualNumber( ) && other.isAnActualNumber( )) {
      return this−>numeric_value( ) + other.numeric_value( );
    }
    // Create equation from one or more left-hand-side variables,
  right-hand-side variables and one operator.
    DarkHashVariable result;
    create_and_save_an_equation({result}, {*this, other_number},
  SupportedOperators::SUM);
    return result;
  }
};
```

In some embodiments, the originally received C++ code is replaced by:

DarkHashVariable compute_polynomial(DarkHashVariable x,
DarkHashVariable y, DarkHashVariable z) {
return 4 * x * x − 3 * x * y + 12 * x * z * z * z − 45;
}

Next, the following lines of code are called:
DarkHash Variable var1(“X”), var2(“Y”), var3(“Z”);
DarkHash Variable result=compute_polynomial(var1, var2, var3);

Implementing the above code results in the following equations:
1. EQ0: Equation ([T0], [4, X, X], MULT),
2. EQ1: Equation ([T1], [−3, X, Y], MULT),
3. EQ2: Equation ([T2], [12, X, Z, Z, Z], MULT), and
4. EQ3: Equation ([T4], [TO, T1, T2, 45], SUM).

### An Optimized Version of the Dag of FIG. 2

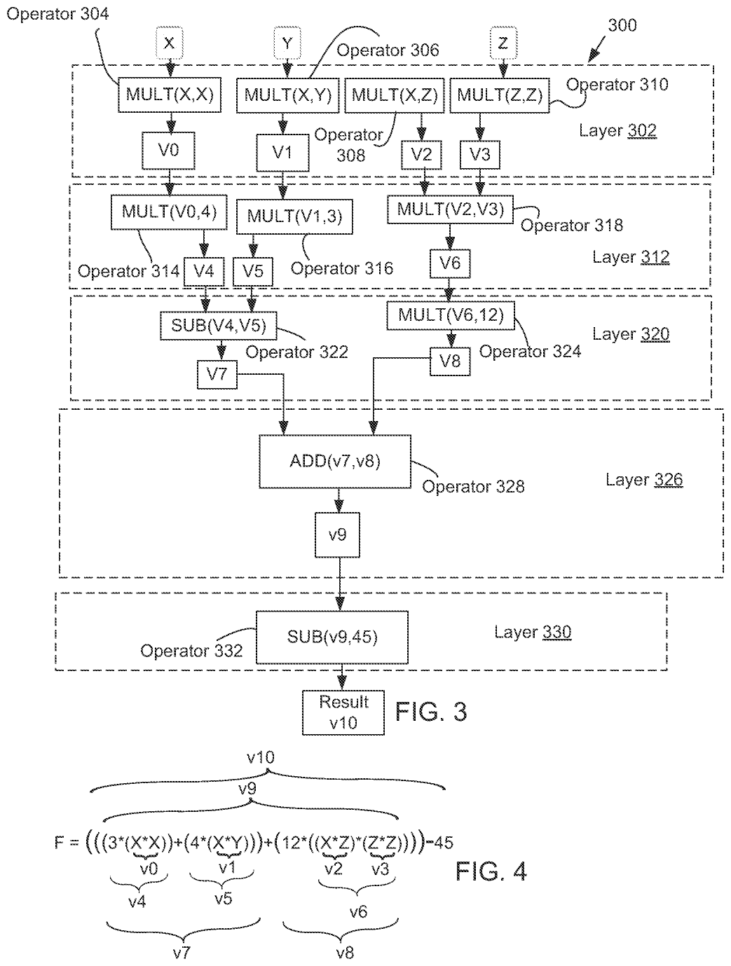

FIGS. 3 and 4 will be discussed together. FIG. 3 illustrates an example of DAG 300 created from the equation of FIG. 2. FIG. 4 illustrates the equation from which the DAG 300 of FIG. 3 is created. The parentheses of FIG. 4 illustrate the order in which the operators of the DAG 300 of FIG. 3 are computed. In creating the DAG of FIG. 3, the DAG optimizer 106 of the system 100 applied the constraint of using only binary operators. Accordingly, the operators of FIG. 2 are divided into multiple operators to form the DAG 300 of FIG. 3.

In FIG. 4, the operations within the smaller parentheses represent operations that are performed first, and operations within larger parentheses are performed later. The smallest parentheses indicate the first layer (layer 302) of operators of FIG. 3, which includes an operator 304, an operator 306, an operator 308, and an operator 310, which results in V0, V1, V2 and V3, respectively. Each layer is a group of operators sharing a common property. In FIG. 2, each layer is made up of operators executed simultaneously (i.e., at approximately the same time). The next to the smallest parenthesis corresponds to the next layer (a layer 312) of operators of the DAG 300, which includes an operator 314, an operator 316 and an operator 318, and which results in results V4, V5 and V6, respectively. The next largest parenthesis corresponds to the next layer (a layer 320) of operators of the DAG, having an operator 322 and an operator 324, which result in results V7 and V8, respectively. The next largest parenthesis corresponds to the next layer (a layer 326) of operators having an operator 328, which results in a result V9. Finally, in a layer 330, the operator 332 receives a result V9 as an operand to produce the output of the algorithm, V10.

In some embodiments, there are time delays that control when the operators are implemented. In some embodiments, the amount of current connecting one node to another is stored in the edges of the DAG (in some embodiments, the current in the edges are gate drives, and the operators are implemented by logic gates).

In some embodiments, the edges include storage units for storing metadata describing nearby nodes from which the edges emerge.

### An Example of Optimizing a Dag

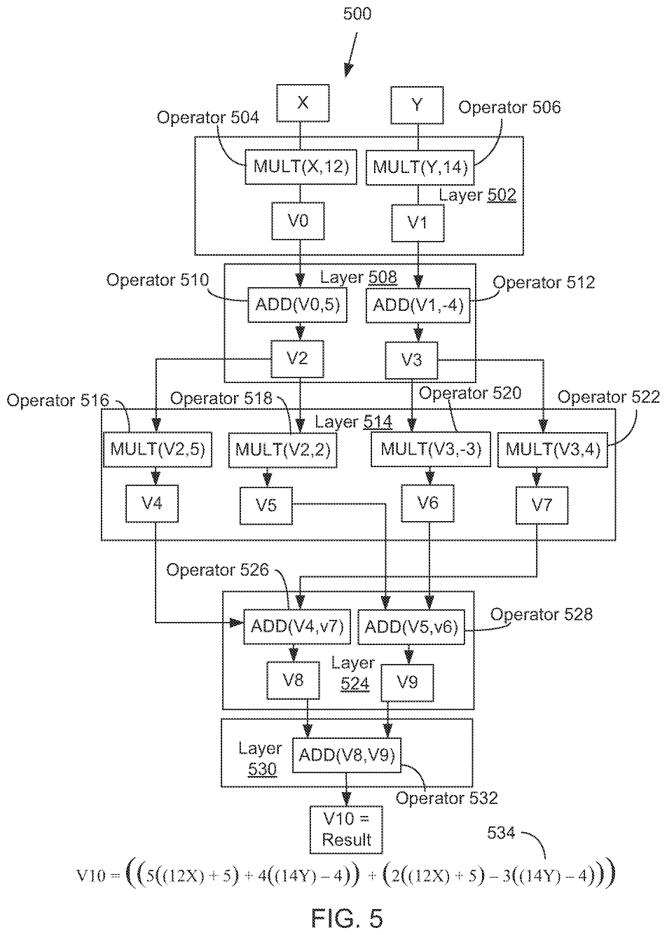

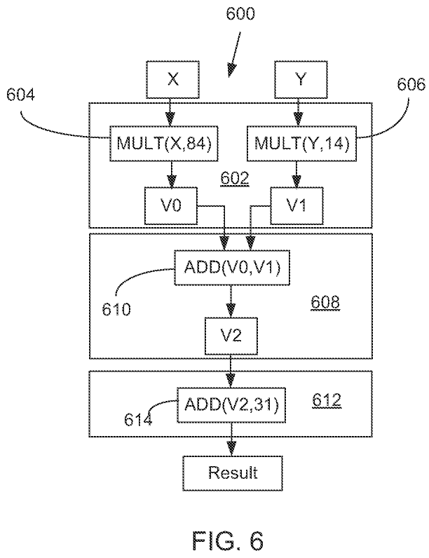

FIGS. 5 and 6 illustrate an example of combining operators (to optimize the DAG). FIG. 5 is an example of a DAG 500 of an algorithm prior to combining subDAGs. FIG. 6 illustrates a DAG 600 of an algorithm that results after combining subDAGs. First, the algorithm of FIG. 5 is described and then a method of optimizing the algorithm is described. In FIG. 5, in a layer 502, an operator 504 multiplies X by 12, and an operator 506 multiplies 14 by Y, and the results of a layer 502 are:

$$V 0 = 12 X ;$$

$$and$$

$$V 1 = 14 Y .$$

In a layer 508, an operator 510 adds 5 to V0, and an operator 512 subtracts 4 from V1. The results of the layer 508 are:

$$V 2 = V 0 + 5 = 12 X + 5 ;$$

$$and$$

$$V 3 = V 1 - 4 = 14 Y - 4 .$$

In a layer 514, an operator 516 multiplies V2 by 5, an operator 518 multiplies V2 by 2, an operator 520 multiplies V3 by −3 and an operator 522 multiplies V3 by 4. The results of the layer 514 are:

$$V 4 = 5 V 2 = 5 ( 12 X + 5 ) = 60 X + 25 ;$$

$$V 5 = 2 V 2 = 2 ( 12 X + 5 ) = 24 X + 10 ;$$

$$V 6 = - 3 V 3 = - 3 ( 14 Y - 4 ) = - 42 Y + 12 ;$$

$$and$$

$$V 7 = 4 V 3 = 4 ( 14 Y - 4 ) = 56 Y - 16 .$$

In a layer 524, an operator 526 adds V4 to V7, and an operator 528 adds V5 to V6. The results of the layer 524 are:

$$V 8 = V 4 + V 7 = ( 60 X + 25 ) + ( 56 Y - 16 ) = 60 X + 56 Y + 9 ;$$

$$and$$

$$V 9 = V 5 + V 6 = ( 24 X + 10 ) + ( - 42 Y + 12 ) = 24 X - 42 Y + 22 .$$

In a layer 530, an operator 532 is implemented, adding V8 to V9. The result of a layer 530 is:

$$V 10 = V 8 + V 9 = ( 60 X + 56 Y + 9 ) + ( 24 X - 42 Y + 22 ) = 84 X + 14 Y + 31 .$$

The initial algorithm of FIG. 5 can be expressed as:

$$V 10 = ( ( 5 ( ( 12 X ) + 5 ) + 4 ( ( 14 Y ) - 4 ) ) + ( 2 ( ( 12 X ) + 5 ) - 3 ( ( 14 Y ) - 4 ) ) ) \qquad ( Equation 534 )$$

As in FIG. 4, the sequence in which the operators are evaluated in the equation 534 is by the size of the parentheses. In some embodiments, to optimize the initial algorithm of FIG. 5, the successive operations on the same term can be replaced with the resulting value of the coefficient. Applying the communitive, distributive and associative laws to separately collect the X terms together, Y terms together and constant terms together, yields:

$$V 10 = ( ( 5 ( 12 X ) ) + ( 2 ( 12 X ) ) ) + ( 4 ( 14 Y ) ) + ( - 3 ( 14 Y ) ) ) + ( ( 5 ( 5 ) + 4 ( - 4 ) ) + ( 2 ( 5 ) - 3 ( - 4 ) ) )$$

Collecting the X, Y, and constant terms, removes the addition of the operators 510 and 512 from the computation of the X and Y terms and the layer 502 from the computation of the constant term, partly optimizing the algorithm of FIG. 5. In some embodiments, terms of the same type are collected by implementing algebraic properties of the operators. In some embodiments, terms of the same type are the same functions of the same variables to the same power. Combining the multiplications of the layer 514, yields:

$$V 10 = ( ( 7 ( ( 12 X ) ) ) ) + ( ( ( 14 Y ) ) ) ) + ( ( 7 ( 5 ) + ( - 4 ) ) ) .$$

Performing the computations on the coefficients of X, coefficients of Y and the constants, separately, which effectively combines the multiplications the layers 502 and 514 (thereby combining combinable operators), and the additions of the layers 508, 524 and 530, yields:

$$V 10 = ( ( ( 84 X ) + ( 14 Y ) ) + 31 ) ,$$

which is the algorithm of FIG. 6.

In some embodiments, the system 100 checks whether combining terms results in a simplification. Specifically, the extent to which the algorithm can be simplified could depend on the amount of memory available and the number of operators considered together. For example, in FIG. 5, although the operators 516 and 518 can be combined and the operators 520 and 522 can be combined unless one inspects both the layers 524 and 530, it is not clear whether the combination of the operators 520 and 522 and the operators 524 and 530 results in the simplification, because V4 and V5 are each used differently from one another, and V6 and V7 are used differently from one another. In some embodiments, to arrive at the new DAG of FIG. 6, in some embodiments, a symbolic expression for the final result is derived, and then the resulting expression is converted into a DAG. In some embodiments, the symbolic expressions are derived for intermediate results, which are then broken down into subDAGs that are combined. In some embodiments, the process of deriving intermediate expressions simplifying the expression and then converting the simplified intermediate expressions into subDAGs is repeated.

In some embodiments, the operators of the subDAGs that can be combined are found by identifying operators that affect the same constants. For example, identifying two operators that modify the coefficient of the same symbolic variable or equation term and identifying two operators that alter the value of the same additive constant are indications that the two operators can be combined. For example, all of the operators that create results V3 through V10 of FIG. 5 perform an operation that affects the additive constant, 31. All of the operators that affect the constant can be combined to determine the value of the constant. Similarly, all of the operators except for the operators that result in V4 and V5 affect the coefficient of Y, and all of the operators except for those that result in V6 and V7 affect the coefficient of X.

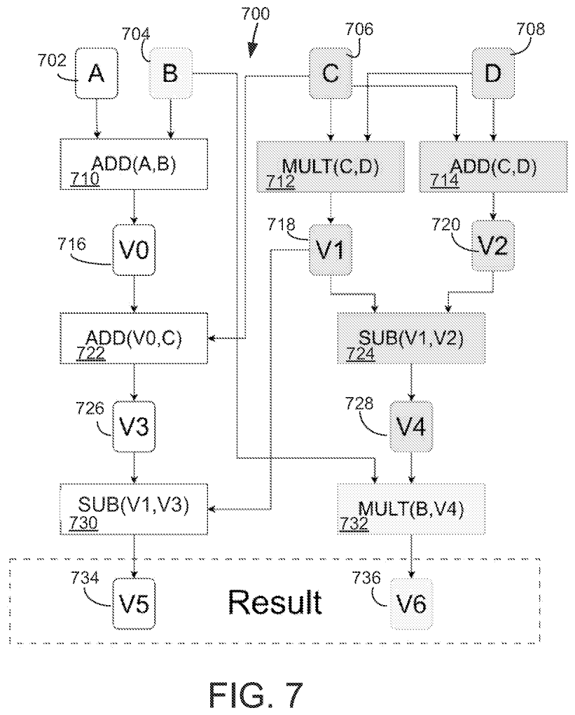

FIG. 7 illustrates an example of tracing a DAG 700 backward to determine which inputs affect a particular output. In some embodiments, the tracing backward can be performed layer-by-layer. In the example of FIG. 7, as each step is performed, the operators, operands, and results found and the relationships between the operators and operands are labeled (and in some embodiments recorded). In some embodiments, a DFS (Depth First Search) and/or BFS (Breadth First Search) are used for searching and labeling the nodes of the DAG. In some embodiments, operands of operators are found and then the operators are found that generate the results used as the operands found. The process is repeated until the inputs to the algorithms are reached. If there are multiple outputs of interest, the system traverses the DAG backward from each of the multiple outputs of interest. When searching for the next node that needs to be probed, a node is traversed only if the node has not been labeled before. In the case of BTC mining, the outputs of interest include just 64 bits. Using each bit as a different output, the DAG has 64 roots. If the components operate on words instead of bits (a word is a 32-bit number), then the DAG would have 2 roots. After tracing the DAG from each output of interest to inputs, the system 100 finds a first collection of nodes that have been labeled, and a second collection of other nodes that have not been labeled, facilitating separating the DAG into two smaller DAGs.

For example, the result of the DAG that is of interest is a result 736 (V6), which results from an operator 732 (MULT (B, V4)). Following the DAG backward, the operands of the operator 732 are an input 704(B) and a variable 728 (V4). A variable 728 (V4) is a result of an operator 724 (SUB (V1, V2)). Continuing backward along the DAG, the operands of the operator 724 are variables 718 (V1) and 720 (V2), which in turn are results of operators 712 MULT (C, D) and 714 ADD (C, D), respectively. Following the DAG further backward, the operands of the operators 712 and 714 are inputs 706(C) and 708(D). Thus, as indicated by the shading, in the example of FIG. 7, result V6 is affected by inputs B, C and D, but not by input A.

The remainder of the DAG that has not been identified/traced can be ignored and the associated computations can be skipped. In the example of FIG. 7, the part of the DAG that does not need to be computed includes an input 702, an operator 710 (ADD (A, B)), a variable 716 (V0), an operator 722 (ADD (V0, C)), a variable 726 (V3), an operator 730 (SUB (V1, V3)) and an output 734 (V5).

Similarly, a DAG can be traced forwards to determine which parts of the DAG are affected by a particular input. Specifically, a determination is made as to which operators (a first set of operators) receive a particular input, directly, as an operand. Then, the results of the first set of operators are determined. Next, a second set of operators (the operators that use the result found from the first set of operators and operands) are determined. The process is repeated until the last layer and the outputs of the DAG are arrived at. As indicated by the shading of FIG. 7, input B only affects the operation of the last layer and the output V6 of the DAG 700. To simplify parallel DAGs, by tracing the inputs forward, when portions of the sets of inputs are similar, the portions of the DAG that are of interest that perform the same computation (as a result of sharing the same input) can be computed just once (and then applied to all DAGs to which the computation is relevant). In the example of FIG. 7, if multiple DAG 700s are arranged in parallel and use the same values for inputs C and D, then the computations of the operators 712, 714 and 724 only need to be performed once, and the results (V4) can be used in both DAGs.

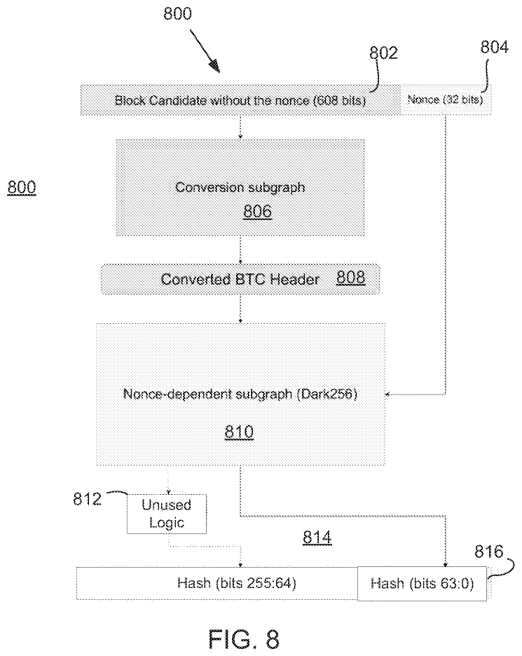

FIG. 8 illustrates a system 800 and the flow of information for creating a hash (system 800 is an example of a system created by the system 100 and methods of FIGS. 14-16, which are discussed below). The system 800 has two inputs which include a block candidate 802 and a nonce 804. The block candidate is operated upon by a conversion subDAG 806 that is not affected by the nonce. The results of a conversion subDAG 806 are converted to a modified BTC header 808. In some embodiments, the conversion subDAG 806 converts a standard BTC header to the input for the mining chip and is not on the BTC mining chip. The modified BTC header 808 and the nonce 804 are input to the nonce-dependent subDAG 810. The nonce 804 is not unique to any block. In some embodiments, the nonce 804 is part of a block's header and can be used as a “knob” that can be tuned to various values to test whether the resulting hash has a value low enough (less than a current threshold set by the protocol) to create a new crypto coin. As mentioned earlier, when mining BTCs, in performing the computation, only the last 64 bits need to be computed repeatedly. The other bits, hash bits 814, are only computed on-chip (e.g., by the system 800) when the last 64 bits are all zeros. Accordingly, the portion of the subDAGs that are not used for computing the last 64 bits can be ignored and left off the mining chip and implemented elsewhere. In various embodiments, a subDAG 810 has between 800-832 input bits (depending on various factors) and can result in saving 10-15% of logical operations when computing a SHA256 hash, with respect to even the most optimized SHA256D implementations. Depending on what bits are probed and what bits are shared among cores, different DAGs can be obtained with different properties, some embodiments have 20-25% less logic and memory gates (than a standard circuit for computing a SHA256D hash).

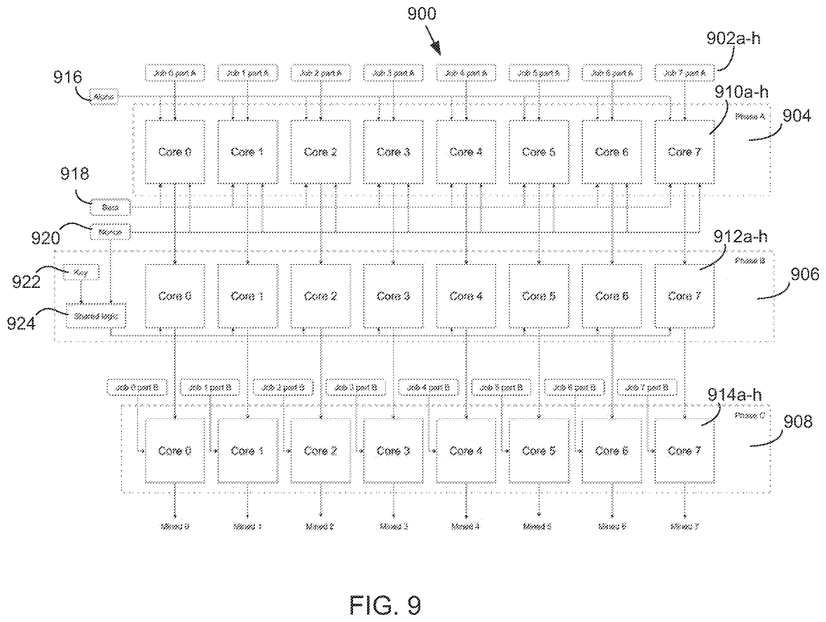

FIG. 9 illustrates a block diagram of various embodiments of a constellation 900, which is an embodiment of a multi-core system for computing a hash. By contrast, the nonce-dependent DAG 810 has only a single core.

A constellation is a group of similar DAGs that are placed in a collection of DAGs near each other (analogous to a constellation of stars), which in some embodiments share resources. In some embodiments, many of the DAGs of the constellation implement the same algorithm and are performed in parallel.

There are many ways of merging DAGs. To facilitate merging DAGs, by reducing redundant logic, a search is performed for similar/or shared bits among the inputs of the DAGs. If certain inputs can be “shared” among multiple block candidates, then some of the operators defined in the DAGs can also be “shared” or reused. Only one copy of the shared components/nodes/operators are needed and the nodes only need to be executed once, and the results are reused for all other DAGs of the constellation, hence decreasing the overall number of operators per hash. The constellation processes multiple blocks in parallel and is the result of combining multiple cores. Assuming data from eight BTC headers are processed in parallel, using the constellation, a large DAG having 4864 input bits, 2048 output bits, and millions of components are combined to form the execution graph.

The constellation 900 operates on multiple (in some embodiments 8) parallel jobs 902a-h. Each job is a 576-bit number required by each core in the constellation that is unique to that job. For a constellation of eight cores, eight 576-bit numbers are required (totaling 4608 bits). The constellation includes multiple phases (in some embodiments 3 phases) of logic, a phase 904 (a phase A), a phase 906 (a phaseB) and a phase 908 (a phase C). The three phases (904, 906 and 908) are three different procedures. The phase 904 includes cores 910a-h, the phase 906 includes cores 912a-h and the phase 908 includes cores 914a-h. The constellation receives constants alpha 916 and beta 918, a nonce 920 and a key 922 as inputs into the phase 904 of the constellation 900. The constants alpha 916 and beta 918 are each 32-bits long. The key 922 is a 192-bit number fed into the shared logic 924. The combination of the alpha 916, the beta 918 and the key 922 form a block candidate, similar to the block candidate 802.

Each job includes a part A and a part B. Part A is a 320-bit number required by the constellation's phase 904, and part B is a 256-bit number that is required by phase 908 of the constellation. The combination of the parts A and B form a 526-bit number that is unique for each job. The shared logic 924 receives nonce 920 and key 922 as input. The output of the shared logic 924 is shared by cores 912a-h. The three phases (904, 906 and 908) differ in which input each receives (among other things) and which part of the job each phase processes. Specifically, phase 904 receives part A of the job, alpha 916, beta 918 and the nonce 920. Phase 906 receives the output of phase 904 and the output of shared logic 924. The same nonce 920 is shared by the cores 910a-h of the constellation and is used by the BTC protocol to validate a mined block. In some embodiments, each of the three phases 904, 906 and 908 have a unique set of constraints.

Each of the phases 904, 906 and 908 can be broken down into a set of component clusters, which can be referred to as component clusters and which are not found in conventional BTC mining chips. Each component cluster is a group of components of the DAG merged to form a logical element. The component clusters are similar to building blocks, from which the phases 904, 906 and 908 can be constructed.

The ordering of the input and output bits of each component cluster or other modules can be optimized to minimize wire overlaps on the die, and the ordering of the inputs above is just for demonstration purposes. Using an embodiment of system 900 produced by system 100, the overall number of summations needed per hash is Σ=942×N+110, where N is the number of modules in the constellation.

If N=8, the constellation requires a total of 7647 additions to calculate 8 mined signals, which is 14% fewer additions than the standard implementation of SHA256D. A conventional BTC mining chip has an input of 640 bits, and the system 900 has an input of 832 bits. The current BTC mining chip with 8 cores has a DAG with 4864 input bits and 2048 output bits. A conventional BTC mining chip with 8 cores has significantly fewer inputs than the current BTC mining chip. The propagation delay between layers is a fixed number of hops for a SHA hash and there is a fixed propagation delay between layers or an integral multiple of the fixed propagation delay. However, the subDAG 810 and 900 would have a different propagation delay and a different number of hops than a conventional BTC mining chip. The propagation delay of the systems 810 and 900 are not an even multiple of the standard propagation delay, and the number of hops per layer of the systems 810 and 900 are not an even multiple of the standard number of hops per layer of a BTC mining chip. A standard BTC mining chip would have 128 rounds of bit scrambling. By contrast, the systems 810 and 900 accomplish the same amount of bit scrambling with only 60 to 90 rounds of bit scrambling, which requires less memory.

Conventional BTC mining chips have a relatively standard number of inputs. Inputs are either 640 bits for cores that directly accept block candidates or multiples of 256 bits+96 bits for cores that accept a midstate of the block candidates. By contrast, a core of the system 810 accepts between 798 and 832 bits depending on the embodiments.

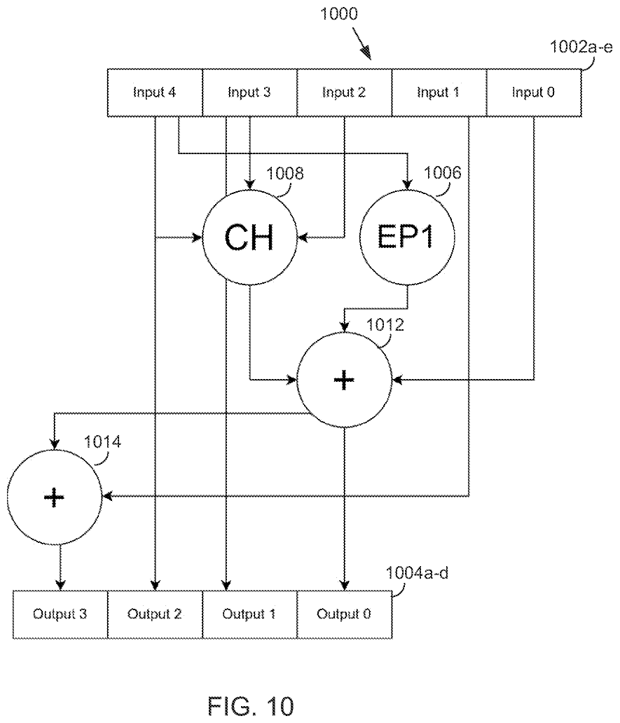

FIGS. 10-13 each illustrates a different component cluster of various embodiments of a constellation for BTC mining.

FIG. 10 illustrates various embodiments of a first component cluster 1000. Component cluster 1000 receives 5 inputs 1002a-e and produces 4 outputs 1004a-d. Inputs 1002e are fed into a SHA256 function, EP1 1006. The inputs 1002c-e are fed into a SHA256 function, a CH 1008 (CH (x,y,z)=(xΛy)⊕(¬xΛz), where Λ is a bitwise AND operator, ⊕ is a bitwise EXCLUSIVE OR operator and ¬ is a bitwise negation operator). The input 1002e is used as the output 1004c. The output of CH 1008 is used as the output 1004b. Additionally, the output of CH 1008 is added, via a sum 1010, to the output of an EP1 1006 and the input 1002a. The output of sum 1010 is added, via a sum 1012, to the input 1002b, and the result of the sum 1012 is used as the 1004d (output o).

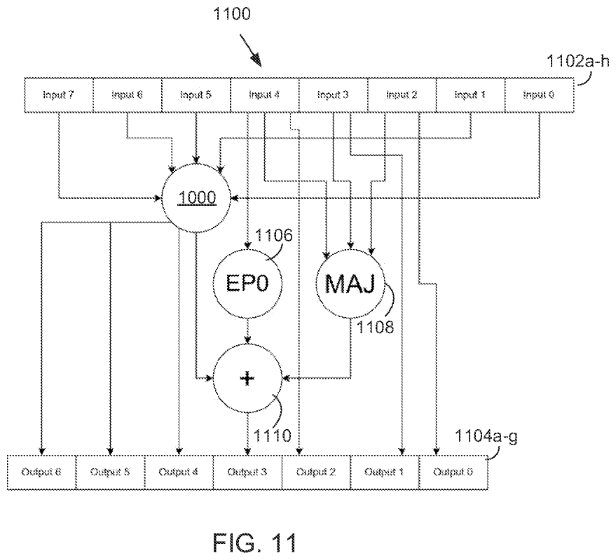

FIG. 11 illustrates various embodiments of a second component cluster 1100. The component cluster 1100 receives inputs 1102a-h (a 256-bit input) and creates results 1104a-g (a 224-bit output).

The inputs 1102b and f-h are used as input to the method 1000. The outputs of method 1000 are used as the outputs 1104e-g of the method 1000. The input 1102c is used as the output 1104a, and the input 1102e is used as the output 1104c. The input 1102e is fed to the EP1 function 1106. The inputs 1102c-e are inputs of a MAJ function 1108 (MAJ(x,y,z)=(xΛy)⊕(xΛz)⊕(yΛz)). The outputs of the method 1000, the EP1 1106 and the MAJ 1108 are added together, by an addition 1110. The output of the addition 1110 is used as the output 1104d.

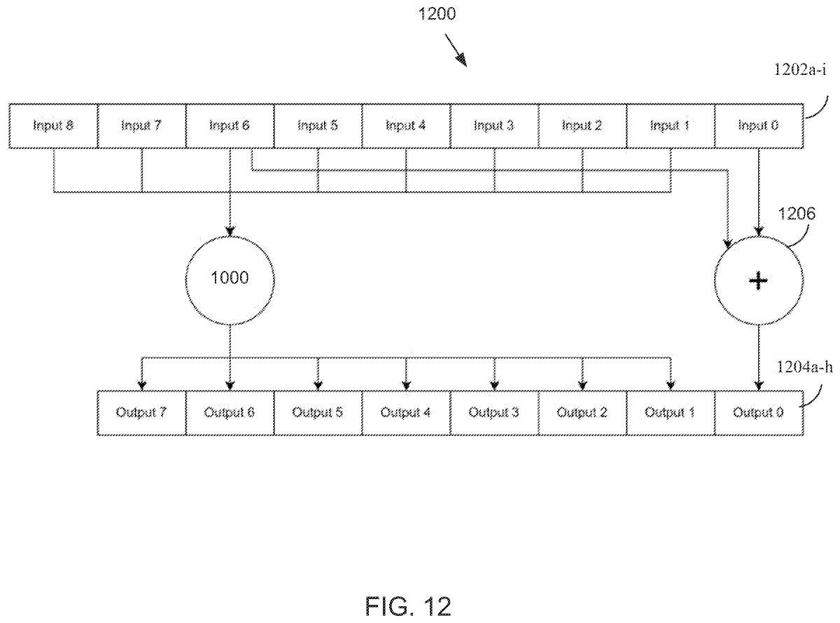

FIG. 12 illustrates various embodiments of a third component cluster 1200. The component cluster 1200 includes inputs 1202a-i and outputs 1204a-h. The nputs 1202b-i are fed to the method 1000, which generates the outputs 1204b-h. The inputs 1202a and 1202h are added together by an addition 1206. The output of the addition 1206 is the output 1204a.

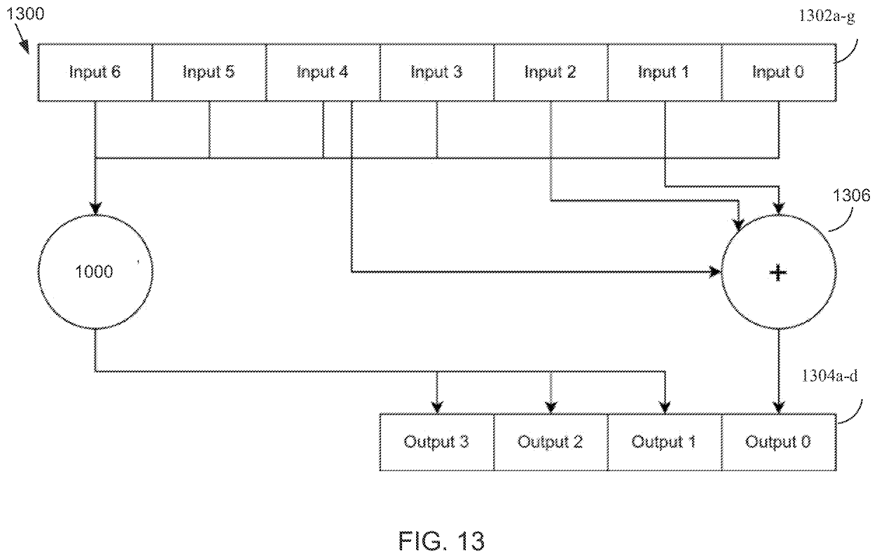

FIG. 13 illustrates various embodiments of a third component cluster 1300. The component cluster 1300 includes inputs 1302a-g and outputs 1304a-d. The inputs 1302a-g are fed to the method 1000, which generates the outputs 1304b-d. The inputs 1302b, 1302c and 1302e are added together by an addition 1306, and the result of the addition 1306 is the output 1304a.

FIG. 14 illustrates a flowchart of an example of a method 1400 for converting an initial algorithm to a new algorithm and creating a device based on the new algorithm.

In a step 1402, an initial algorithm is received, via the I/O 108 (as described in conjunction with FIG. 1). See the discussion of FIGS. 2 and 5 for examples of initial algorithms. In some embodiments, the step 1402 is performed by a logic circuit. In other embodiments, the step 1402 is performed by a neural network. In a step 1404, the constraints are received via the I/O 108 (see the discussion of FIG. 1 for some examples of the constraints).

In a step 1406, the operators of the initial algorithm are identified, via the code parser 102 (as described above in conjunction with FIG. 1).

In a step 1408, the operands of the operator and results of the operators are identified, via the code parser 102 (as described above in conjunction with FIG. 1). In a step 1410, the operands and results are converted to symbolic variables, via the code parser 102 (as described above in conjunction with FIG. 1). In some embodiments, the symbolic variables are represented by binary variables. In some embodiments, operators are detected and numeric variables are replaced by symbolic variables by assigning the variables found a custom type (see the discussion of the code snippets described above in conjunction with FIG. 2).

In a step 1412, a sequence of operators is determined, and a DAG is created, by the DAG builder 104 (as described in conjunction with FIG. 1). The DAG of FIGS. 2 and 5 are examples of the initial DAG constructed in the step 1412.

In some embodiments, the DAG constructed by the DAG builder 104 is represented by pointers forming a linked list. In some embodiments, the step 1412 is performed simultaneously with, or as part of, the steps 1408 and 1410.

In a step 1414, outputs of interest are identified (some of the outputs identified in the step 1414, may not be of interest) by the DAG optimizer 106 (as discussed in conjunction with FIG. 7).

In a step 1416, the inputs that affect the outputs of interest are identified by the DAG optimizer 106. In various embodiments, the step 1416 involves following, by DAG optimizer 106, the edges of the DAG backward from the outputs of interest to the inputs, labeling the nodes traversed (see the discussion of FIG. 7, the output V6 and the inputs B-C).

In a step 1418, the DAG is divided, by the the DAG optimizer 106, into a portion of interest and a portion that is not of interest. The portion of the DAG that is not of interest is discarded or ignored (see the discussion of FIG. 7).

In a step 1420, the DAG of interest is further divided, by the DAG optimizer 106, into smaller subDAGs. In some embodiments, individual operators are replaced with combinations of simpler operators (see FIG. 3 and FIG. 6 for example in which the operators of FIG. 2 and FIG. 5, respectively, have been replaced by simpler operators).

In a step 1422, the operators are combined, based on the constraints (see the discussion of FIGS. 5 and 6, which give an example of combining operators).

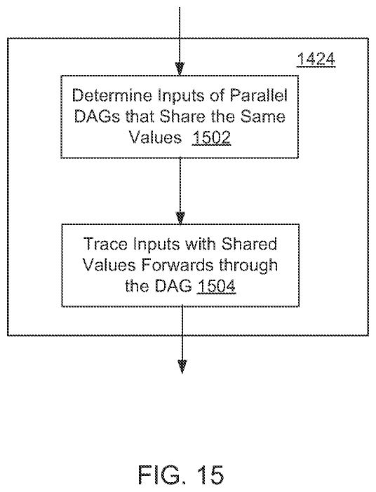

In a step 1424, the parallel DAGs are combined into a constellation in which the parallel DAGs are combined by sharing one copy of the shared logic 924 (instead of having a separate copy for each DAG). See the discussion of FIGS. 7 and 15.

In a step 1426, a finished product that implements the algorithm is created, by the device builder 120. In some embodiments, the finished product includes an ASIC. In some embodiments, the finished product is a programmed processor.

FIG. 15 illustrates a flowchart of various embodiments of a step 1424 for creating a constellation based on an algorithm (see FIG. 9 for an example of a constellation).

After the step 1422 of the method 1400, the method 1400 proceeds to a step 1502. In a a step 1502, inputs to parallel DAGs that have the same value are identified, by DAG (the shared inputs), as discussed in conjunction with FIG. 7. In a step 1504, the shared inputs are traced forwards through the DAG and labeled by DFS. The labeled nodes are used to determine the computations of the DAG that only need to be done once for all DAGs, as discussed in conjunction with FIG. 9. After the step 1504, the method 1400 proceeds to the step 1426.

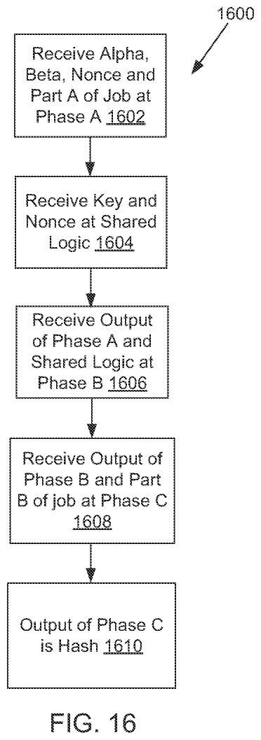

FIG. 16 illustrates a flowchart of various embodiments of a method 1600 of operating the device constructed by the method of FIG. 14 for computing multiple hash values in parallel. In a step 1602, constant values are received, which include the value of parts A of the job, alpha, beta and nonce at, and processed by, the phase A (the phase 904) of the constellation 900, as described in conjunction with FIG. 9. In a step 1604, the nonce and a key are received at, and processed by, the shared logic 924, as described in conjunction with FIG. 9. In a step 1606, the output of phase A and the shared logic 924 are received at, and processed by, the phase B (the phase 906), as described in conjunction with FIG. 9. In a step 1608, the output of the phase B and the part B of the job are received at the phase C (the phase 908), as described in conjunction with FIG. 9. The output of phase C is the last 64 bits of the hash.

Although the disclosed method and apparatus are described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above-disclosed embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system comprising:
a) a processor system having one or more processors; and
b) a memory system storing one or more machine instructions, which when implemented by the processor system cause a method to be implemented, the method including at least
(i) receiving a first algorithm at the system, the first algorithm being in a machine implementable format;
(ii) receiving one or more constraints at the system;
(iii) converting, by the processor system, the first algorithm to a directed acyclic graph;
(iv) reconstructing, by the system, the directed acyclic graph based on the constraints; and
(v) constructing, by the system, a second algorithm, based on the directed acyclic graph the second algorithm being in a machine implementable format.

2. The system of claim 1, wherein
the converting of the first algorithm including traversing the directed acyclic graph from outputs of interest to inputs that affect the outputs of interest; and
the method further comprising:
discarding portions of the directed acyclic graph that were not traversed.

3. The system of claim 1, the method further comprising:
a) dividing the directed acyclic graph into subgraphs; and
b) combining the subgraphs to reduce how many computations the second algorithm performs.

4. The system of claim 1, the method further comprising:
a) identifying variables of the first algorithm; and
b) converting the variables to symbolic variables.

5. The system of claim 1, the method further comprising:
a) identifying operators of the first algorithm; and
b) the constructing of the directed acyclic graph including creating nodes based on the operators.

6. The system of claim 1, the constructing of the directed acyclic graph comprising:
a) identifying operators of the first algorithm;
b) identifying operands of the operators;
c) identifying results of the operators; and
d) matching results of operators with operands of subsequent operators.

7. A system, comprising:
a) a processor system having one or more processors; and
b) a memory system storing one or more machine instructions, which when implemented by the processor system cause a method to be implemented, the method including at least
(i) receiving a first algorithm at the system;
(ii) receiving one or more constraints at the system;
(iii) converting, by the processor system, the first algorithm to a directed acyclic graph;
(iv) reconstructing, by the system, the directed acyclic graph based on the constraints;
(v) constructing by the system, a second algorithm, based on the directed acyclic graph; and
constructing an integrated circuit that implements the second algorithm.

8. The system of claim 1, wherein nodes of the directed acyclic graph include operators.

9. The system of claim 1, wherein nodes of the directed acyclic graph include symbolic variables.

10. The system of claim 1, wherein the one or more constraints include a limit on how many lookup tables are in the second algorithm.

11. The system of claim 1, wherein the one or more constraints include a limit on how much area on a chip is required by an integrated circuit to implement the second algorithm.

12. The system of claim 1, wherein the one or more constraints include a limit on how many operators are implemented simultaneously.

13. The system of claim 1, wherein the one or more constraints include a limit on a maximum delay between adjacent layers.

14. The system of claim 1, wherein the first algorithm mines a cryptocurrency.

15. The system of claim 14, wherein portions of the first algorithm produce an output that includes two portions; a first of the two portions is constant and a second of the two portions changes, the second algorithm only includes inputs that affect the second of the two portions of the output.

16. The system of claim 14, wherein
the first algorithm produces an output that includes two portions;
a first of the two portions is constant and a second of the two portions changes, the second algorithm being based on only portions of the first algorithm that affect the second of the two portions of the output.

17. The system of claim 14, the method further comprising receiving a nonce and a block candidate, wherein the second algorithm computes an output based on the nonce and the block candidate.

18. The system of claim 17, the method further comprising:
a) inputting the block candidate by a conversion subgraph and converting the block candidate into a converted candidate block; and
b) inputting the nonce and the converted candidate block into a portion of the second algorithm represented by a directed acyclic graph that computes a portion of the output that changes with changes in the converted candidate block based on the nonce.

19. A method comprising:
a) receiving, at a system, a first algorithm, the first algorithm being in a machine implementable format, the system including at least
(i) a processor system having one or more processors and
(ii) a memory system storing one or more machine instructions, which when implemented by the processor system cause the method to be performed;
b) receiving, by the system, one or more constraints;
c) converting, by the processor system, the first algorithm to a directed acyclic graph;
d) reconstructing, by the system, the directed acyclic graph based on the constraints; and
e) constructing, by the system, a second algorithm, based on a directed graph, the second algorithm being in a machine-implementable format.

20. The method of claim 19 further comprising:
the converting of the first algorithm including traversing the directed acyclic graph from outputs of interest to inputs that affect the outputs of interest;
discarding portions of the directed acyclic graph that were not traversed.
